(19) United States
(12) Patent Application Publication
(10) Pub. No.: US 2015/0170032 A1
(43) Pub. Date: Jun. 18, 2015

(54) Accelerometer-Based Movement Prediction System

(71) Applicant: Google Inc., Mountain View, CA (US)

(72) Inventors: Jeffrey Harris HODES, New York, NY (US); Arunesh Mishra, Sunnyvale, CA (US)

(21) Appl. No.: 13/912,833

(22) Filed: Jun. 7, 2013

Related U.S. Application Data
(60) Provisional application No. 61/657,295, filed on Jun. 8, 2012.

(51) Int. Cl. G06N 5/02

(52) U.S. Cl. CPC G06N 5/02

(57) ABSTRACT

Various embodiments of systems and methods to control whether data is collected from an accelerometer of a mobile device based on a predictive model of the mobile device's past movements are described. A mobile device may transmit time-stamped accelerometer data to a networked computer. The networked computer may use the received data to build a movement prediction model for the associated mobile device and transmit the model back to the mobile device. The mobile device may execute an algorithm to turn off power to the accelerometer during periods of time that movement is known based on the movement prediction model. Decreasing the time that data is collected from the accelerometer improves battery life performance of the mobile device.

### BACKGROUND

1. Field

The field relates to mobile devices.

2. Background

Determining the location of mobile devices has been performed using a variety of methods. One common technique involves the use of a global positioning system (GPS) to determine the coordinates of a mobile device. However, GPS is unreliable while indoors or in some comparably challenging environment and requires significant battery power for constant data collection. Wireless signals (such as, WIFI signals) have been used. For example, wireless signal strength data collected from one or more access points in range of the mobile device may be used to compute a location. Such wireless data collection uses considerable power which is especially problematic on a mobile device as it can drain available battery power.

Accelerometers have been used in conjunction with mobile devices to determine movement characteristics of the mobile device. The data from the accelerometer can be used to distinguish whether the mobile device is stationary or moving. Constant polling of data from the accelerometer though places a constant drain on battery power, which is not ideal.

### BRIEF SUMMARY

A method performed by a networked computer for building a movement prediction model of a mobile device is described. The method includes accessing accelerometer data associated with one or more mobile devices, building one or more movement prediction models based on the accessed accelerometer data, and transmitting the one or more movement prediction models to the one or more mobile devices.

In an embodiment, a networked computer system includes a receiver, a storage unit, a processor, and a transmitter. The receiver subsystem is configured to receive accelerometer data from one or more mobile devices. The storage unit is configured to store the accelerometer data associated with each mobile device. The processor executes an algorithm for building a movement prediction model for each mobile device based on the accelerometer data collected for each mobile device. The transmission subsystem is configured to transmit the movement prediction model to its associated mobile device.

A method performed by a mobile device is described. The method includes receiving a movement prediction model generated based on past accelerometer movements of the mobile device, and storing the model in a storage unit. The method further includes controlling when data is collected from the accelerometer, associated with the mobile device, based on the movement prediction model.

In an embodiment, a computer readable storage medium contains instructions executed by either a computing device or a mobile device to perform methods as described above.

### BRIEF DESCRIPTION OF THE DRAWINGS/FIGURES

The accompanying drawings, which are incorporated herein and form a part of the specification, illustrate embodiments of the present invention and, together with the description, further serve to explain the principles of the invention and to enable a person skilled in the pertinent art to make and use the invention.

FIG. 1 is a diagram illustrating a network between a mobile device and a networked computer, according to an embodiment.

FIG. 2 is a diagram of the various components within a mobile device, according to an embodiment.

FIG. 3 illustrates a movement prediction model timeline and associated accelerometer status, according to an embodiment.

FIG. 4 is a method for receiving accelerometer data, according to an embodiment.

FIG. 5 is a method for building a movement prediction model, according to an embodiment.

FIG. 6 is a method for controlling accelerometer output based on the movement prediction model, according to an embodiment.

Embodiments of the present invention will be described with reference to the accompanying drawings.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

It is noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

Modeling a user's movement patterns based on the collected data from a mobile device associated with the user and predicting future movement patterns is difficult to perform without consuming large amounts of power. In a feature described herein data modeling user movement may be used to supplement location tracking techniques such as WIFI fingerprinting, cell tower triangulation, or GPS tracking to further refine the accuracy of the user's location. Furthermore, the data may be used to predict future movement behavior which may reduce the need to rely on traditional location tracking techniques and increase battery life. In an embodiment, building a model to predict a user's future movement involves analyzing past accelerometer measurements of a mobile device associated with the user to look for patterns in the measurements. In an embodiment, the mobile device wirelessly transmits its accelerometer data to a networked computer where the model is built and returned to the mobile device. It should be understood that the measurement of a user's movement is not limited to only being performed by an accelerometer and that any suitable device for determining user movement could be utilized.

Once received by the mobile device, the movement prediction model may be utilized in a variety of ways. In an embodiment, the movement prediction model determines when the accelerometer should be polled for data, increasing battery life during periods of time that the accelerometer is not used. In another embodiment, the movement prediction model determines when the mobile device should perform a scan such as a WIFI scan) to refresh the signal strength data related to each access point in range of the mobile device. For example, if the model predicts that a user will be stationary for a set period of time, there would not be a need to refresh the WIFI signal strength data during that time since the user has not moved so the data will not have changed.

In an embodiment, collection of acceleration data and the generation and usage of a movement prediction model is carried out under an opt-in policy where a user first indicates his or her approval and opts to have these features.

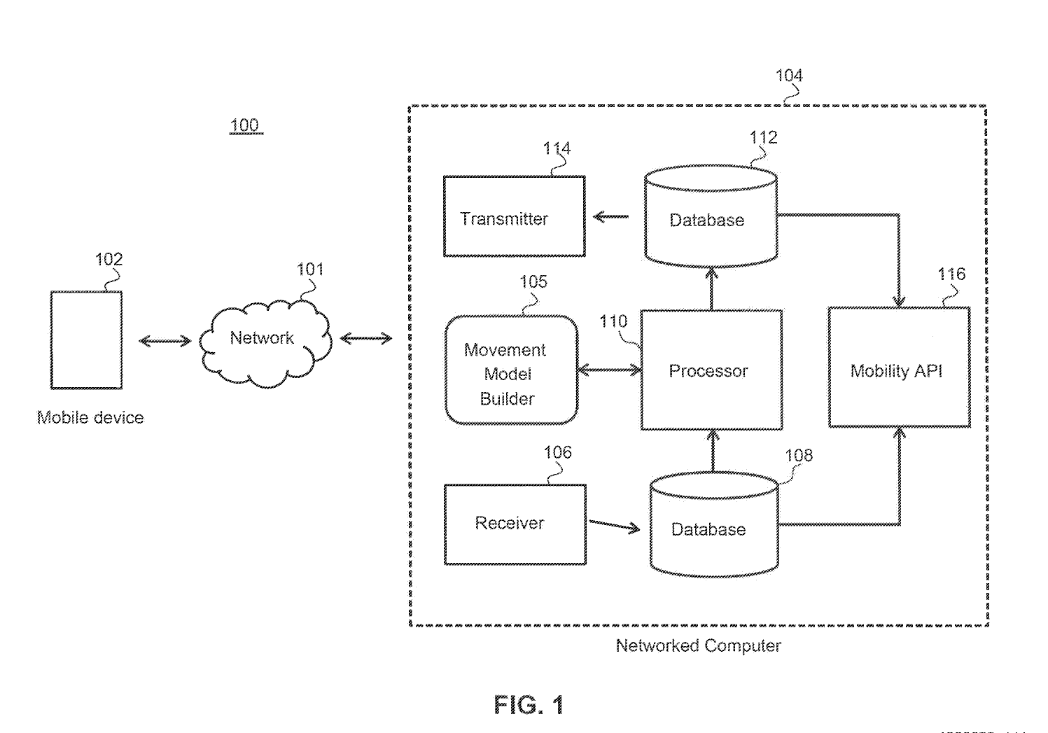

FIG. 1 illustrates an example mobile network system 100 according to an embodiment. Mobile network system 100 may include a mobile device 102 which communicates with networked computer 104 via network 101, It should be understood that mobile network 100 may include any number of mobile devices in communication with networked computer 104. in an embodiment, signals passed between mobile device 102 and networked computer 104 via network 101 may be transmitted through any means, or combination thereof, known to a person skilled in the art which include, but are not limited to, WIFI, Bluetooth, 3G, 4G, etc. Network 101 may include any network or combination of networks, such as the Internet, a wide area network, wireless network, telephone network, or local area network. Furthermore, wireless transmission of any data associated with network 101 over long distances may be achieved by the data first being received by a closest one or more cell towers (not shown) for routing the data to networked computer 104.

Networked computer 104 may include one or more standalone computers, a server, a server farm, or a cloud-computing server. Mobile device 102 may include a smartphone, tablet computer, personal digital assistant, or similar mobile communications device that can connect to networked computer 104 via network 101. Mobile device 102 may be a device that is frequently carried by the user. In an embodiment, a mobile device may be any device with the ability to wirelessly send and receive data.

In an embodiment, networked computer 104 includes a movement model builder 105, a receiver 106, a first storage unit 108, a processor 110, a second storage unit 112 and a transmitter 114. Data, including data generated from movement model building 105, may be stored as a database on either first storage unit 108 or second storage unit 112. Movement model builder 105 can be implemented in software, firmware, hardware or any combination thereof. In one example, movement model builder 105 can be implemented on processor 110. In one example, movement model builder 105 controls and carries out methods 400 and 500.

Receiver 106 and transmitter 114 may include any components recognized by those skilled in the art for the purpose of receiving, transmitting and/or modulating data. In an embodiment, the actions performed by receiver 106 and transmitter 114 may be performed by one or more transceivers. Such transceivers may include, antennas, analog to digital converters, digital to analog converters, low pass filters, band pass filters, oscillators, multiplexers, demultiplexers, etc. Furthermore, such transceivers may include one or more interfaces to access wired or wireless networks such as Ethernet network and Wi-Fi networks, and/or one or more interfaces such as USB and Bluetooth to couple proximately located devices.

In an embodiment, receiver 106 is configured to receive accelerometer data from mobile device 102. The received data is stored in database 108. The data may contain information regarding any one of an acceleration magnitude, direction, or time that the data was collected. As such, all received data is inherently timestamped, according to an embodiment. Any or all of the information within the received accelerometer data may be used to build the movement prediction model for mobile device 102, according to an embodiment.

First storage unit 108 and second storage unit 112 may be any known storage medium to those skilled in the art including, but not limited to, random access memory (RAM), flash memory, hard disk drive, etc. Although first storage unit 108 and second storage unit 112 are displayed as two separate components for the sake of clarity, it should be understood that networked computer 104 may include any number of singular or combined storage unit components.

Processor 110 can be a processor, such as, but not limited to, a microprocessor, field programmable gate array (FPGA), or digital signal processor (DSP). Processor 110 is configured to access the accelerometer data from first storage unit 108 and execute an algorithm to build a movement prediction model based on the data, according to an embodiment. The model provides a prediction of whether the user of mobile device 102 would be stationary at a given time, according to an embodiment. Alternatively, the model may provide a prediction of a constant movement profile for a given time, for example, if the user is in a car which produces a particular acceleration signature. Once the model has been built, it may be stored in second storage unit 112.

Transmitter 114 may be configured to transmit the movement prediction model to mobile device 102 via network 101. The movement prediction model may remain stored in second storage unit 112 or may be erased after a period of time. In an embodiment, the movement prediction model and/or the accelerometer data may be accessed via an optional mobility application programming interface (API) 116. The mobility API 116 may be configured to apply the data or model towards backend applications running on networked computer 104. Examples of these backend apps include a calendar, mapping, or proximity application.

In an embodiment, the proximity application may be used to compare movement prediction profiles or accelerometer data collected from two or more mobile devices to determine relative proximity between the devices. For example, if two mobile devices each share similar accelerometer data over a period of time, then it is likely that both devices are in the same moving vehicle, and therefore are close to one another.

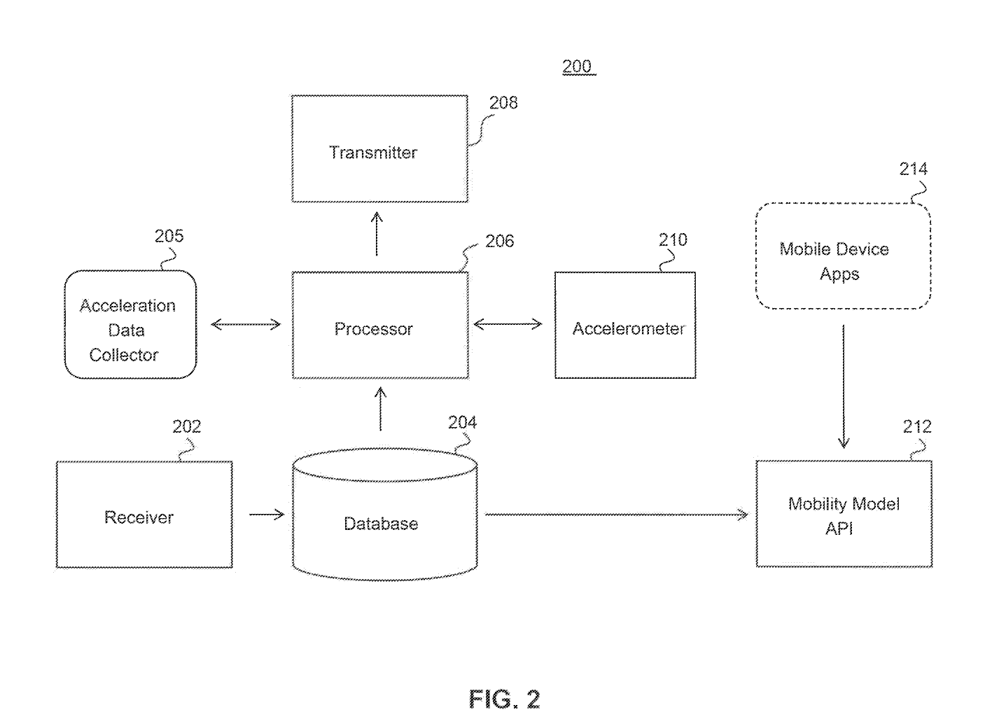

FIG. 2 displays an illustration of a mobile device system 200 according to an embodiment. Mobile device system 200 represents subcomponents of an embodiment of mobile device 102. Mobile device system 200 includes a receiver 202, a storage unit 204, a processor 206, a transmitter 208, an acceleration data collector 205, and an accelerometer 210. Acceleration data collector 205 can be implemented in software, firmware, hardware, or any combination thereof. In one example, acceleration data collector can be implemented on processor 206. In one example, acceleration data collector 205 controls and carries out method 600. Receiver 202 and transmitter 208 may include any components or interfaces as described previously for the analogous components within networked computer 104.

Receiver 202 may be configured to receive a movement prediction model transmitted by networked computer 104. The movement prediction model may be stored in storage unit 204.

Processor 206 can be a processor, such as, but not limited to, a microprocessor, field programmable gate array (FPGA), or digital signal processor (DSP). Processor 206 may be configured to interact with the movement prediction model stored in storage unit 204 as well as with accelerometer 210. Processor 206 may also interface with transmitter 208.

In an embodiment, accelerometer data collected from accelerometer 210 is accessed by processor 206 and transmitted via transmitter 208 to networked computer 104. Accelerometer 210 may be a single three-axis accelerometer, two-axis accelerometer or any collection of single axis accelerometers. In an embodiment, accelerometer 210 contains a gyroscope and the acceleration data contains data measured from the gyroscope.

In an embodiment, processor 206 accesses the movement prediction model stored in storage unit 204 to determine whether or not to poll data from accelerometer 210. If no data is polled, then no data is consequently transmitted. The determination may be performed by comparing a current time with the model. For example, if the model predicts that the movement of the device is known for the current time, then data from accelerometer 210 does not need to be polled by processor 206. Alternatively, if the model does not designate a particular movement profile for the current time, then processor 206 may continue to poll accelerometer data from accelerometer 210.

Similar to mobility API 116 as described for networked computer 104, mobile device system 200 may also include a mobile model API 212 which interacts with the movement prediction model stored in storage unit 204. Mobile model API 212 may be configured to apply the movement prediction model towards mobile device applications 214. Examples of mobile device applications 214 include any mapping applications, friend locator applications, games, calendar applications, etc.

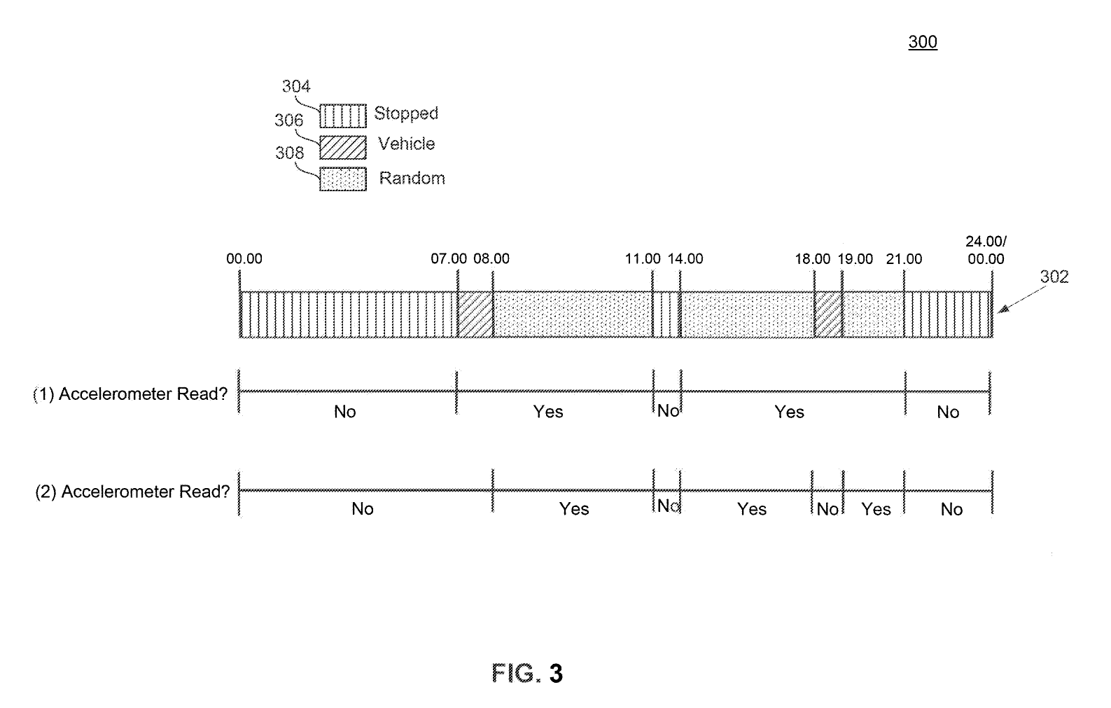

FIG. 3 illustrates an example of a movement prediction model 302. The model is shown over the course of a single 24 hour day, however, in an embodiment, the model may be used to predict movement over any period of time. The model is built through the acquisition of accelerometer data collected from an associated mobile device over a period of time until an accurate prediction can be made. For example, accelerometer data may be collected over the course of a week to predict daily movement activities. In another example, accelerometer data may be collected over the course of a month to predict weekly movement activities or to create a more accurate daily prediction.

It should be understood that although mention is made of the model being used to predict the movement of a particular user, the prediction is technically made for the movement associated with a mobile device, according to an embodiment. However, it is assumed that the mobile device and the user are closely linked throughout the course of a typical day. The mobile device may be a smartphone or other PDA type device which the user would generally keep close by throughout the day. As such, the predicted movements of the mobile device can be considered to be closely related to the predicted movements of the associated user.

In movement prediction model 302, three status indicators have been used for various times throughout the model, according to an embodiment. These status indicators designate the type of movement that the model predicts the user to be doing during the associated time period. The exemplary status indicators include a stopped indicator 304, a vehicular movement indicator 306, and a random movement indicator 308. Other examples of status indicators may include movement patterns associated with exercising, or determining the type of vehicle based on the movement such as differentiating between a car, train, bicycle, etc. The use of three status indicators in movement prediction model 302 is not meant to be limiting and it should be understood that any number of status indicators can be used within a movement prediction model.

Each of the status indicators are used throughout designated time periods of movement prediction model 302. In an example, the model may predict a typical work day of a user. In such an example, the stopped indicator 304 from the time period of 00:00 to 7:00 hours may correspond to the user sleeping. Continuing the example, the time period of 7:00 to 8:00 hours may correspond to the user driving to work, using vehicular movement indicator 306. From 8:00 to 13:00 hours, movement prediction model 302 may have received various accelerometer data each day, and as such, cannot make an accurate prediction of the user's movement. In this scenario, random movement 308 indicator may be applied during the hours of 8:00 to 13:00. In another embodiment, however, movement prediction model 302. makes the closest prediction it can based on the data as to movement patterns of the user at any given time. Movement prediction model 302 may predict stopped indicator 304 from 13:00 to 14:00 which could, for example, correspond to a meeting the user has each day at that time. Random movement indicator 308 may be used to predict the movement from 14:00 to 18:00 and from 19:00 to 21:00 hours, The user may drive home from work starting at 18:00 hours to about 19:00 hours which is predicted with the vehicular movement indicator 306 during that time period. The user may watch television and then go to sleep after 21:00 hours, which requires very little movement, and could be assigned the stopped indicator 304 during this time period.

Various embodiments could be considered regarding controlling the accelerometer output associated with a mobile device during the course of a day modeled by movement prediction model 302. Two exemplary embodiments are illustrated in FIG. 3 for the purposes of description. Other embodiments relating to the control of any other components or programs associated with the mobile device based on movement prediction model 302 may be considered as well.

In the first embodiment, the accelerometer associated with a mobile device, for which movement prediction model 302 is designed, does not share acceleration data during any time periods for which stopped indicator 304 is predicted. For the example illustrated, the accelerometer would not be accessed during the time periods from 00:00 to 7:00, 13:00 to 14:00, and 21:00 to 24:00.

In the second embodiment, the accelerometer associated with a mobile device, for which movement prediction model 302 is designed, does not share acceleration data during any time periods for which either stopped indicator 304 or vehicular movement indicator 306 is predicted. For the example illustrated, the accelerometer would not be accessed during the time periods from 00:00 to 8:00, 13:00 to 14:00, 18:00 to 19:00, and 21:00 to 24:00.

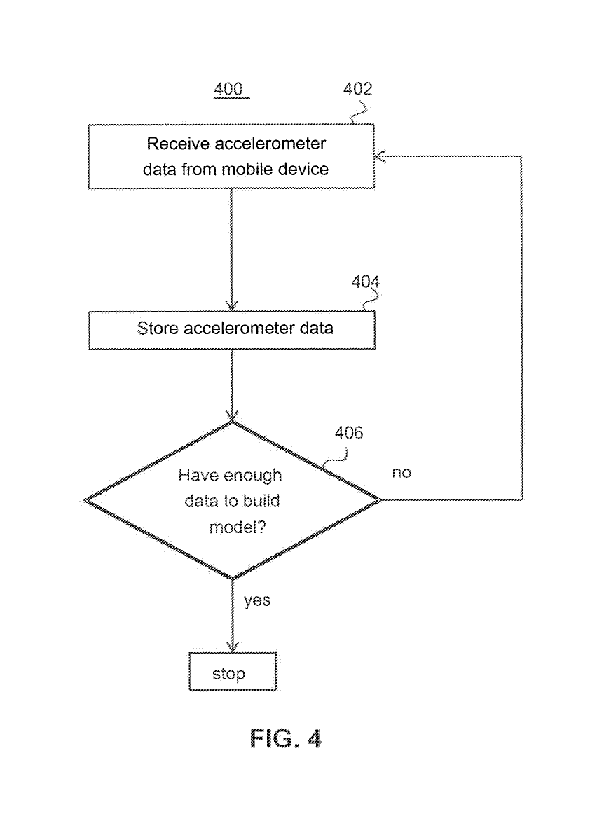

FIG. 4 illustrates an exemplary learning phase method 400 performed by a networked computer. Learning phase method 400 may be performed to collect the accelerometer data used to build the first movement prediction model. Once the first model has been built, data may continue to be collected to further refine the model, or data collection for the purpose of model building may cease. In one embodiment, not intended to be limiting, method 400 can be implemented on networked computer 104 and automatically carried out by movement model builder 105 implemented on one or more processors 110.

At stage 402, accelerometer data is received from a mobile device. It should be understood that accelerometer data may be simultaneously received from a plurality of mobile devices and that the data may include the time that the data was measured and/or transmitted.

At stage 404, the accelerometer data is stored in a storage unit. The data associated with each mobile device may be stored in a separate database or record on the storage unit. Additionally, the data within each database or record may be grouped based on the time that the data was measured by each mobile device.

At stage 406, a determination is made as to whether enough acceleration data has been collected to build the movement prediction model. The model may be used to predict movement over any given time period. The amount of data required to build the model will depend on the time period over which the model is used to predict movement. For example, a movement prediction model covering a time period of a day may require data to be collected over at least a week to build the first model. In another example, a movement prediction model covering a time period of a week may require data to be collected for several weeks.

In an embodiment, the accelerometer data may be analyzed in real time to determine if enough data has been received to build the first model. For example, if the data demonstrates strictly followed movement patterns over a few days, then it may be determined that the amount of collected data is enough to build the first movement prediction model. It should be understood, however, that any amount of data may be considered to be sufficient to build the first movement prediction model. The accuracy of the first model may vary depending on the amount of data collected during learning phase method 400.

If it is determined that enough data has been collected to build the first movement prediction model, then learning phase method 400 ends, according to an embodiment. However, if not enough data has been collected, then learning phase method 400 repeats starting at block 402, according to an embodiment. It should be understood that accelerometer data may continue to be received and stored after the first movement prediction model is built to provide future updates to the model.

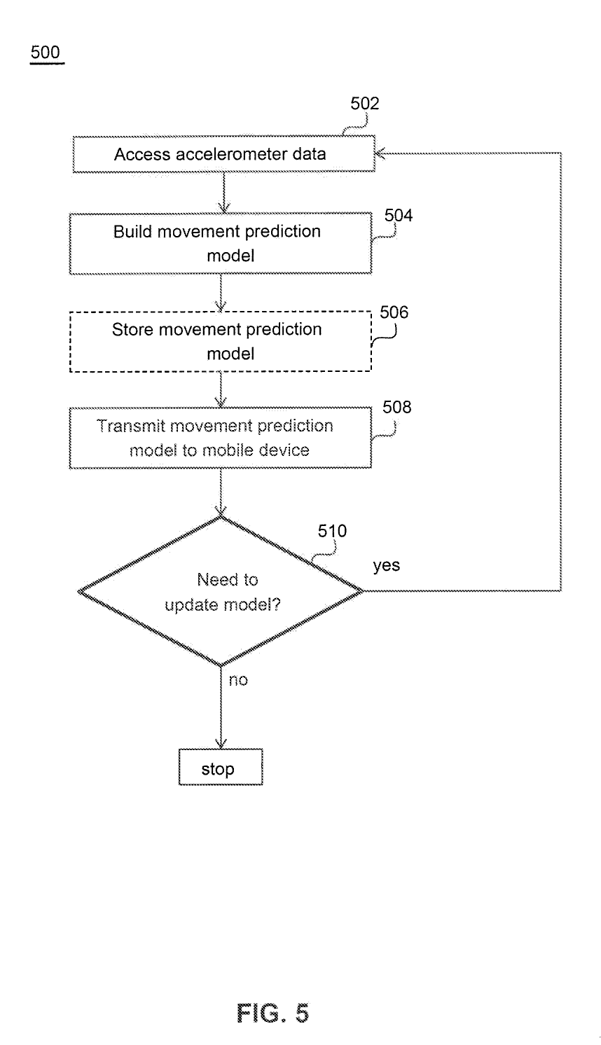

FIG. 5 illustrates an exemplary model building method 500 performed by a networked computer. In an embodiment, model building method 500 would be performed after learning phase method 400 is completed. In one embodiment, not intended to be limiting, method 500 can be implemented on networked computer 104 and automatically carried out by movement model builder 105 implemented on one or more processors 110.

At stage 502, the accelerometer data is accessed from the database for a particular mobile device.

At stage 504, the movement prediction model is built based on the accelerometer data. The model may be built by various comparison techniques of the collected accelerometer data. For example, the amplitude and frequency of the collected data for a given time period may match closely to a known amplitude and frequency profile for the movement of a car. In such an example, the data may then be compared over each day to determine if the model should include the prediction for the given time period. Additionally, any unknown movement pattern, if repeated during the same time period of each day, week, etc., may be included in the movement prediction model as a known movement profile for the time period. In an embodiment, the data may be compared to data collected for other mobile devices to determine joint movement profiles or to determine if two or more mobile devices travel together for any given time periods.

At stage 506, the movement prediction model is stored in a storage unit. In an embodiment, block 506 is an optional step and model building method 500 may proceed from stage 504 to stage 508. The movement prediction model may be stored on the storage unit in order to farther interface with backend applications on a networked computer. Additionally, a second user may request to receive the movement prediction model associated with a first user, so long as the first user has allowed the second user to access the model. For further privacy considerations, the first user may opt to not have the movement prediction model stored at all on the networked computer.

At stage 508, the movement prediction model is transmitted to the associated mobile device. In an embodiment, the model may be transmitted to any mobile device requesting access to the model, as long as access has been permitted by the user of the mobile device.

At stage 510, a determination is made regarding whether the movement prediction model needs to be updated. In an embodiment, the movement prediction model is continuously updated. Any newly collected accelerometer data from the time the last model was built is considered during the building of a new model. Thus, the associated mobile device may also continuously receive an updated movement prediction model. Such an embodiment may provide the most accurate model during changes in the user's normal routine, but may also require the highest amount of computational power and battery drain for the networked computer and the mobile device respectively. In another embodiment, the movement prediction model is updated after a certain time period has passed, for example, the model is updated once a day, three times a week, etc. In yet another embodiment, the model is only updated if it is determined that the movement profiles over a given time period have changed beyond a given threshold. For example, if a user undergoes the same movement profile routine each day for 2 weeks, the model may not need to be updated during that time. However, if the user goes on vacation and the movement profile is suddenly different for the first day of the vacation, stage 510 may determine that the model needs to be updated.

If it is determined that the model does not need to be updated, then model building method 500 ends, according to an embodiment. However, if it is determined that the model does need to be updated, then model building method 500 repeats starting at stage 502, according to an embodiment.

Although model building method 500 has been described as being performed by a networked computer with the movement prediction model being transmitted to a mobile device, it should be understood that the method may similarly be performed by the mobile device. In an embodiment, the mobile device builds and stores the movement prediction model from its own collected accelerometer data. One advantage to having a networked computer build the model as opposed to the mobile device is the benefit of saving battery life on the mobile device.

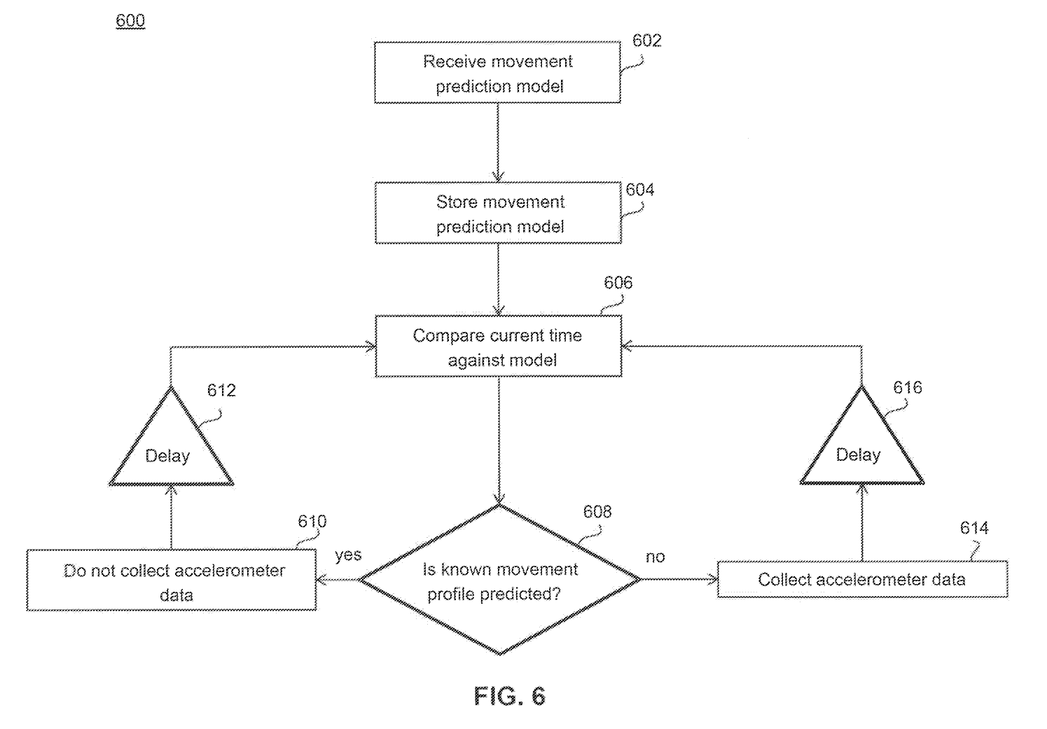

FIG. 6 illustrates an exemplary control method 600 performed by a mobile device. In an embodiment, control method 600 is performed to control when data from an accelerometer is accessed based on a received or stored movement prediction model. In another embodiment, control method 600 is performed to control when the mobile device performs any other operation based on the movement prediction model such as WiFi scanning, account syncing, etc. For the sake of clarity, description herein of control method 600 will be provided for controlling an accelerometer of a mobile device. In one embodiment, not intended to be limiting, method 600 can be implemented on mobile device 102 and automatically carried out by acceleration data collector 205 implemented on one or more processors 206.

At stage 602, the movement prediction model is received by the mobile device. The model may be received from a networked computer or it may be received from another mobile device, according to an embodiment. Alternatively, the model may be built by the mobile device itself and would already be stored on the mobile device.

At stage 604, the movement prediction model is stored in a storage unit if received from any source external to the mobile device, according to an embodiment.

At stage 606, a comparison is made between the current time and the movement prediction model to determine if there is a known movement profile for the current time. The current time may be calculated using any procedure known to those skilled in the art, including tracking processor clock cycles, measuring from a quartz crystal oscillator associated with the mobile device, etc. In another embodiment, the current time may be accessed via data received from a network connection. The movement prediction model includes movement profiles for various time periods as described earlier in FIG. 3. In another embodiment, stage 606 compares the current time to a movement prediction model associated with one or more other mobile devices different from the mobile device performing control method 600.

Stage 608 determines whether a known movement profile is predicted for the current time, according to an embodiment. For example, using movement prediction model 302 from FIG. 3, if the current time is 6:00, then the model predicts a known movement profile (stopped) for the current time. Alternatively, if the current time is 12:00, then the model does not predict a known movement profile (random) for the current time.

If the model predicts a known movement profile for the current time, then control method 600 proceeds from stage 608 to strage 610. In an embodiment, at stage 610, instructions to cease collecting data from an accelerometer associated with the mobile device are executed. Any time spent not polling data from the accelerometer helps to improve the battery life of the mobile device. Stage 612 illustrates a delay which occurs before the next time comparison against the model is made. Stage 612 may be a delay for the length of time up until the next movement profile in the model. For example, again using the movement prediction model 302 of FIG. 3, if the current time is 6:00, and the mobile device is not collecting further accelerometer data, then the delay may last until the current time is 7:00. The predicted movement profile changes from stopped indicator 304 to vehicular movement indicator 306 at 7:00. In another embodiment, stage 612 may delay for a set period of time, for example, 5 minutes, 10 minutes, etc. In an embodiment, when the delay time has passed, control method 600 proceeds from stage 612 back to stage 606.

Once the delay time has passed, an optional step of checking the accelerometer output may be performed. If the accelerometer output still matches the predicted movement profile, then data stops being polled from the accelerometer and the delay at stage 612 continues. In an embodiment, the delays get shorter after each time the accelerometer is checked to determine if the movement profile has changed. In an embodiment, when the predicted movement profile has changed after polling data from the accelerometer, control method 600 proceeds from stage 612 back to stage 606. The longer the set time for the delay at stage 612, the less accurate the movement prediction model may become over time. However, longer set delays improve battery life longevity as the accelerometer is not accessed for longer periods of time.

If the model does not predict a known movement profile, or predicts “random” movement, for the current time, then control method 600 proceeds from stage 608 to stage 614. In an embodiment, at stage 614, accelerometer data is collected from the accelerometer associated with the mobile device, In an embodiment, the collecting of accelerometer data at stage 614 may also be coupled with a method step of sending the collected data to a networked computer. The accelerometer data may be used to further refine the movement prediction model or for any other location or proximity related application as discussed previously. Stage 616 illustrates a delay which occurs before the next time comparison against the model is made. In an embodiment, the delay at stage 616 is similar to a sampling rate of the accelerometer and the length of time of the delay is the time between acceleration data samples collected at stage 614. In an example, the delay time at stage 616 may set the number of accelerometer data samples collected until a predicted movement profile is known. A short delay time at stage 616 provides more acceleration data samples which aid in building a more accurate movement prediction model. A long delay time at stage 616 requires less computation overall and improves battery life. In an embodiment, when the delay time has passed, control method 600 proceeds from stage 614 back to stage 606.

It should be understood that all method steps performed by either a mobile device or a networked computer may each include instructions stored on a computer readable storage medium and executed by a processor. Any computer readable storage medium may be used as would be known to those skilled in the art, including, but not limited to, RAM, flash memory, electronically erasable programmable read-only memory (EEPROM), hard disk drive, etc.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A networked computer system comprising:
a receiver configured to receive accelerometer data from one or more mobile devices;
a first storage unit configured to store the accelerometer data associated with each of the one or more mobile devices;
a movement model builder, implemented on a processor, configured to build a movement prediction model for each of the one or more mobile devices based on the stored accelerometer data; and
a transmitter configured to transmit the one or more movement prediction models to the associated one or more mobile devices.

2. The system of claim 1, further comprising a second storage unit configured to store the movement prediction model associated with each of the one or more mobile devices.

3. The system of claim 2, wherein the first storage unit and the second storage unit are substantially the same storage unit.

4. The system of claim 1, further comprising a mobility API configured to apply the accelerometer data towards backend applications.

5. The system of claim 4, wherein the backend applications include a proximity application.

6. The system of claim 5, wherein the proximity application compares the accelerometer data of two or more mobile devices to determine their relative proximity.

7. The system of claim 1, wherein the accelerometer data further comprises a timestamp for each accelerometer measurement.

8. The system of claim 7, wherein the movement prediction model predicts movement over a single day based on the timestamps for each accelerometer measurement collected over previous days.

9. The system of claim 7, wherein the movement prediction model predicts movement over a single week based on the timestamps for each accelerometer measurement collected over previous weeks.

10. A method performed by a networked computer, the method comprising:
accessing accelerometer data associated with one or more mobile devices;
building one or more movement prediction models based on the accelerometer data associated with the one or more mobile devices; and
transmitting the one or more movement prediction models to the one or more mobile devices.

11. The method of claim 10, further comprising storing the one or more movement prediction models in a storage unit.

12. The method of claim 10, further comprising:
building the movement prediction model for a particular mobile device only after a threshold amount of accelerometer data is collected from the particular mobile device; and
storing the collected accelerometer data in a storage unit.

13. The method of claim 12, wherein the threshold amount is equal to one week.

14. The method of claim 12, wherein the threshold amount is equal to one month.

15. The method of claim 10, further comprising continuously updating the movement prediction models from accelerometer data collected from the one or more mobile devices.

16. The method of claim 10, wherein building one or more movement prediction models comprises building the models to predict movement over a 24 hour period.

17. The system of claim 10, wherein building one or more movement prediction models comprises building the models to predict movement over a week-long period.

18. A method performed by a mobile device, the method comprising:
receiving a movement prediction model; storing the movement prediction model; and
controlling when data is collected from a component coupled to the mobile device based on the movement prediction model.

19. The method of claim 18, wherein receiving the movement prediction model comprises receiving the movement prediction model from a networked computer.

20. The method of claim 18, wherein receiving the movement prediction model comprises receiving the movement prediction model from within the mobile device.

21. The method of claim 18, wherein controlling when data is collected from a component coupled to the mobile device comprises controlling when data is collected from an accelerometer.

22. The method of claim 21, wherein controlling when data is collected from an accelerometer comprises ceasing to collect data from the accelerometer for a period of time that a user is predicted to be stopped.

23. The method of claim 21, wherein controlling when data is collected from an accelerometer comprises ceasing to collect data from the accelerometer for a period of time that any predicted, consistent movement profile of a user is known.

24. The method of claim 21, wherein controlling when data is collected from an accelerometer comprises changing the sampling rate of data collection from the accelerometer based on a predicted movement profile from the movement prediction model.

25. The method of claim 18, further comprising transmitting the collected data to a networked computer.

26. The method of claim 18, further comprising interfacing between the movement prediction model and applications on the mobile device.

27. The method of claim 26, wherein interfacing comprises interfacing between the movement prediction model and a proximity application.

28. A computer readable storage medium having instructions stored thereon that, when executed by a computing device, cause the computing device to perform operations comprising:
accessing accelerometer data associated with one or more mobile devices;
building one or more movement prediction models based on the accelerometer data associated with the one or more mobile devices;
storing the one or more movement prediction models; and
transmitting the one or more movement prediction models to the one or more associated mobile devices.

29. A computer readable storage medium having instructions stored thereon that, when executed by a mobile device, cause the mobile device to perform operations comprising:
receiving a movement prediction model;
storing the movement prediction model; and
controlling when data is collected from an accelerometer coupled to the mobile device based on the movement prediction model.
